(19) United States
(12) Patent Application Publication
(10) Pub. No.: US 2016/0120739 A1
(43) Pub. Date: May 5, 2016

(54) LUMBAR DECOMPRESSION SUPPORT AND ILEO-CECAL VALVE MASSAGER

(71) Applicant: Jasa Group LLC, Dix Hills, NY (US)

(72) Inventor: Joseph Carozza, Jersey City, NJ (US)

(73) Assignee: JASA GROUP LLC, Dix Hills, NY (US)

(21) Appl. No.: 14/927,224

(22) Filed: Oct. 29, 2015

Related U.S. Application Data
(60) Provisional application No. 62/072,117, filed on Oct. 29, 2014.

(51) Int. Cl. A61H 23/02

(52) U.S. Cl. CPC A61H 23/02; A61H 2205/081

(57) ABSTRACT

A system includes a support structure and a massaging device. The support structure has a width to span a user's torso and a depth to raise the user's torso off of an underlying surface when the user is in a prone position on the support structure. The massaging device is coupled to or embedded within the support structure at an offset location. The offset location allows the massaging device to be nearer to one lateral edge of the support structure than to an opposing lateral edge of the support structure, which in turn allows the user to dispose the massaging device approximately in alignment with the user's ileocecal valve. The massaging device also includes a control switch to control an operating state of the massaging device.

### CROSS-REFERENCE TO RELATED APPLICATIONS

This application claims the benefit of U.S. Provisional Application No. 62/072,117, filed on Oct. 29, 2014, which is incorporated by reference herein in its entirety.

Low back pain (LBP) is a major health issue due to its high prevalence rate and socioeconomic cost. Using our device alters the material properties of the passive components of the spine.

The present invention is in the technical field of medical, therapeutic, and/or relaxation devices.

More particularly, the present invention is in the technical field of lumbar spine decompression, more particularly, the present invention is in the technical field of ileocecal valvular massage.

Conventional decompression devices are typically immovable or difficult to transport. It is difficult to have these devices in a home or office due to their size and weight. Setting up these devices typically requires trained personnel.

Numerous devices and apparatus on the market claim to decompress or stabilize the spine. Some require surgery to place a prosthetic disc or fixation coil in the vertebral area. Others claim to relieve pain by using different pressure and leverage devices to increase vertebral space using a fraction mechanism. All claim relief by stretching vertebral spaces so that the discs get sucked back into proper position using this “pulling” method while lying on their backs. Our method places the subject in the prone instead of the supine position.

Embodiments described herein may be referred to by many names or designations, including in some instances the LB Key. In some embodiments, the LB Key uses an ergonomic support to “push” the muscles, ligaments, tendons and vertebra from an anterior to posterior position. The subject places the support on a flat surface and proceeds to position it under his stomach. This forces the abdomen and its contents upward toward the diaphragm and downward to the pelvis to take pressure off lumbar nerves, muscles and other structures to create the Flexion-Relaxation Phenomenon.

In addition to the support block which can be made from different foams and fillers and covered with fabrics ranging from microfibers and natural fabrics, we have a massage unit for stimulation of the ileocecal Valve.

The ileocecal valve is the gatekeeper between small and large intestine. If the valve is stuck in a closed position, contents are retained and putrefy as the individual becomes constipated. When stuck in an “open” position the reverse takes place as bacteria and contents of the colon back up into the small intestine causing toxicity.

Ileocecal valve massage previously required the assistance of various therapists. The device does not require anyone other than the user and does not require any training

Stimulation of the valve reduces the low back sensation of pain via soothing the enteric nerve reflexes in the model of visceral-somatic pain induced by colorectal distension and inflammation.

Additionally, our design features allow the body to relax while the massage unit stimulates blood flow in the intestines to nourish tissue and “flush out” toxins that accumulate in the area.

Fatigue, bloating, irritable bowel, fluid retention, headaches and nausea are just a few symptoms that result from ICV dysfunction. As in any sewerage system, an incompetent ICV turns the body into a living cesspool of toxic bacteria, viruses and gases living off stagnant putrefactive waste.

The present invention is a lumbar spine support to reduce lower back pain. Strain on the ligaments and muscles are the two most frequently cited sources of low back pain. Our counterstrain device works on the principal of the Flexion-Relaxation Phenomenon. The EMG observation of electrical silence of the erector spinae at flexion is referred to as flexion relaxation (FR). Low back pain has been observed in the majority of patients without the FRP (flexion-relaxation phenomenon).

The two mechanisms of ileocecal valve massage and abdominal decompression shift the moment to the passive structures and redistribute muscle recruitment to deeper muscles not normally activated. This causes muscle relaxation and decreased pain. The valve massage relieves the pain referred to the lower back from abdominal organs. It is lightweight, portable and easy to use.

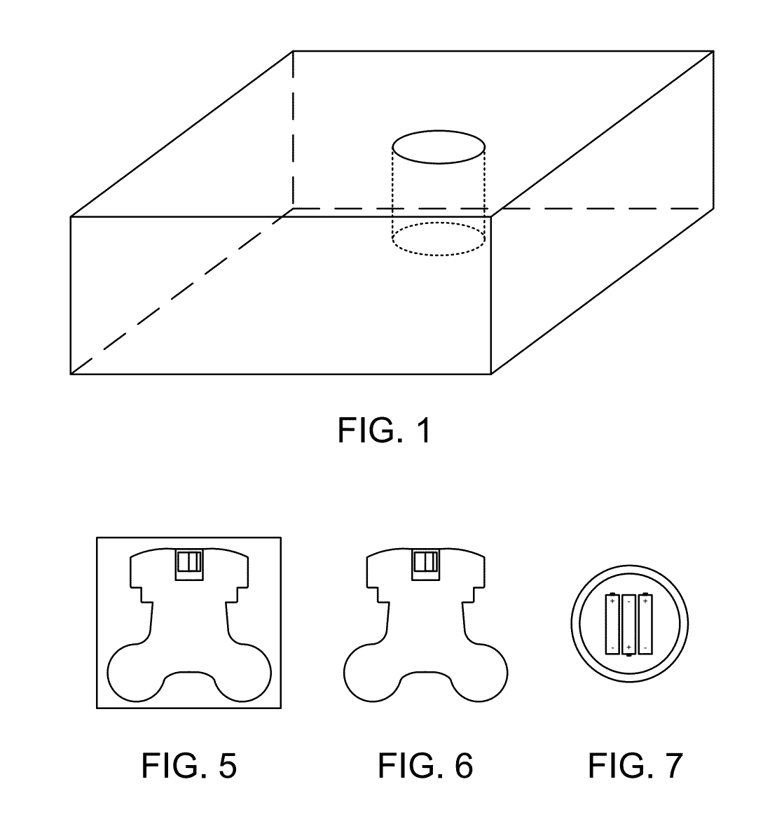

FIG. 1 is a “three” dimensional view of a support structure or block with a circular cutout for a massage device or unit.

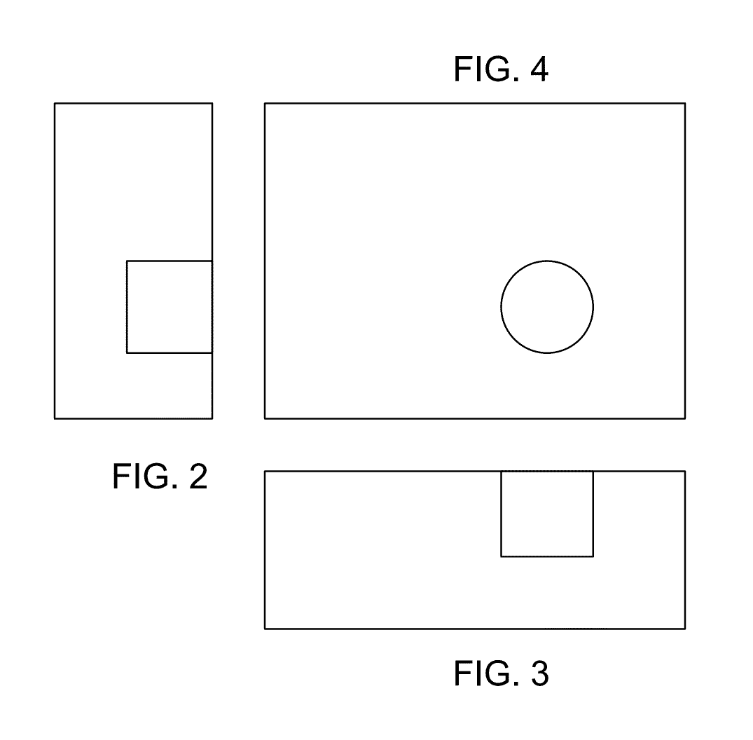

FIG. 2 is a side view showing the support and cutout of the massage unit space.

FIG. 3 is a view showing the top and bottom of the support block with placement of the massage unit.

FIG. 4 is an overhead view of the support block with an aperture for the massage unit.

FIG. 5 is an isolated schematic of the massage aperture and the position of one embodiment of an ‘on/off’ button.

FIG. 6 is an additional isolated schematic of the massage aperture and the position of one embodiment of an ‘on/off’ button.

FIG. 7 is a drawing of the massage unit as seen from the lateral view and overhead view which demonstrates placement of three AAA batteries.

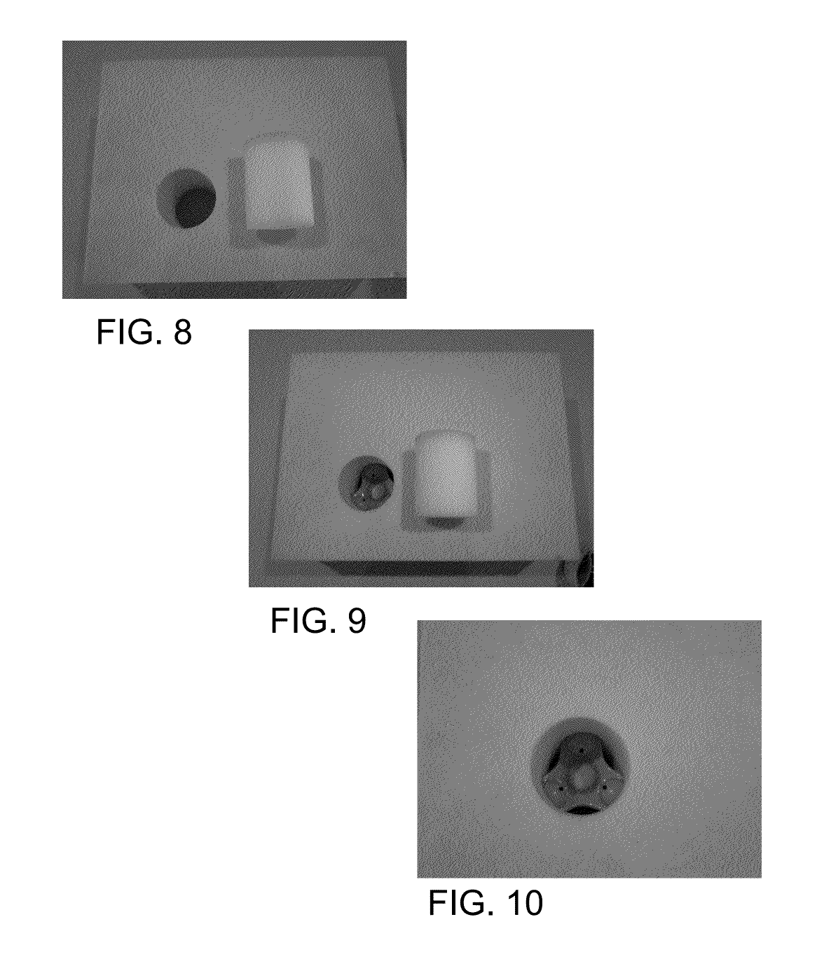

FIG. 8 is a view of the support block with an aperture for the massage unit.

FIG. 9 is a view of the support block with placement of the massage unit.

FIG. 10 is an additional view of the support block with placement of the massage unit.

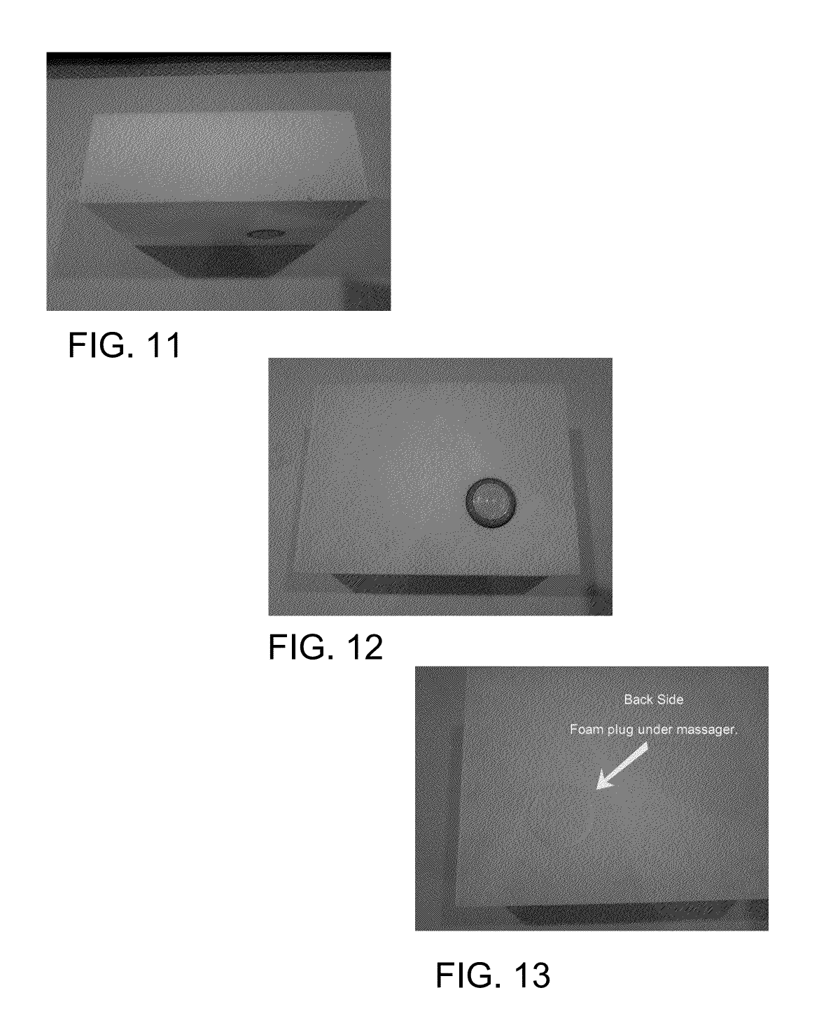

FIG. 11 is a side view of the support block with an aperture for the massage unit.

FIG. 12 is a front view of the support block with an aperture for the massage unit.

FIG. 13 is a back view of the support block.

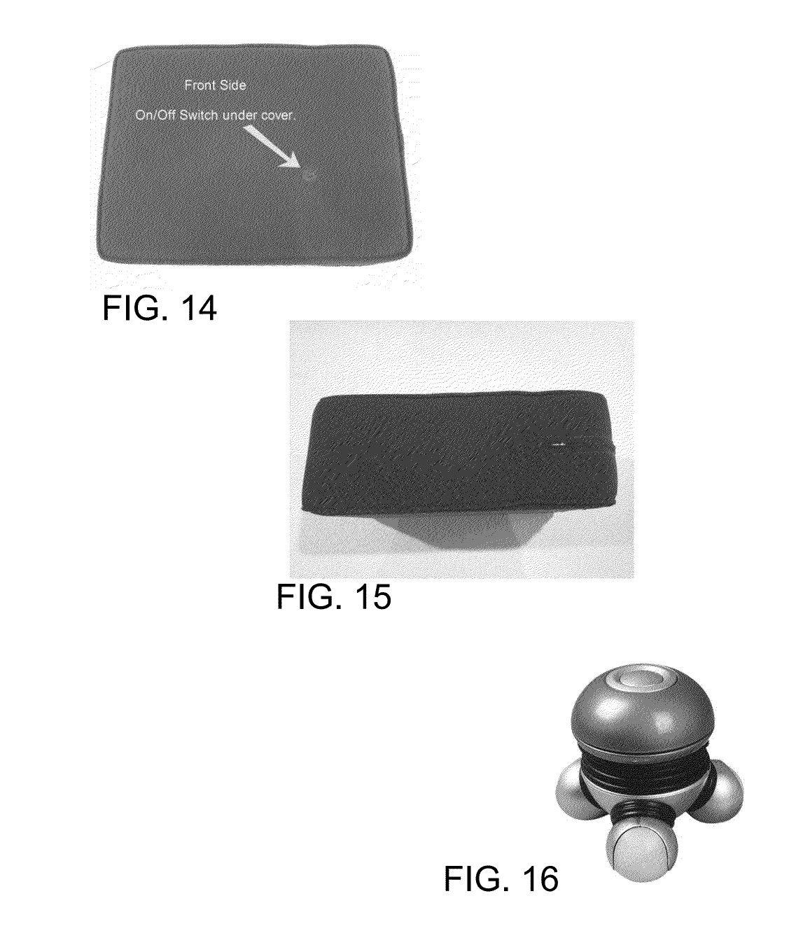

FIG. 14 is a front view of the support block with a cover indicating the on/off switch.

FIG. 15 is a side view of the support block with a cover.

FIG. 16 is an image of an embodiment of the massage unit.

Throughout the description, similar reference numbers may be used to identify similar elements.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments include a support structure and a massaging device. The support structure may be any shape, size, geometry, or material to support a user as described herein. The massage device is inserted into, or otherwise used in combination with, the support structure to provide mechanical or electromechanical massaging movements to the user at the location in contact with or generally adjacent to the massage device. In some embodiments, the massage device is approximately aligned with the user's ileocecal valve, which the user is comfortably supported by the support structure. Approximate alignment can mean that the central or strongest portions mechanical vibrations from the massage device directed to the user's ileocecal valve. In other embodiments, approximate alignment means that the mechanical vibrations or other movements are sufficient in strength at the ileocecal valve to cause relaxation or other muscle reactions with in the general vicinity of the ileocecal valve. In other embodiments, approximate alignment means that the massage device passes below the user's ileocecal valve, when the user is disposed on the support structure and the massage device.

Although a particular shape of support structure is illustrated in the drawings, other embodiment may include different shapes of support structures, including support structures having more or less dramatic curvatures, larger or smaller footprints, angles or slants to support the user's body in a rotated position, and so forth. In other embodiments, the overall geometry and characteristics of the support structure may be adjusted by the user. For example, a user may adjust the support structure to be more firm or more soft, longer or wider, thicker or thinner, and so forth. In other embodiments, the support structure may accommodate multiple locations for the massage device, or for multiple massage devices, so that users of different sizes can adjust the location of the massage device for better a better combination of comfort of the support structure and location of the massage device relative to the user's ileocecal valve.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system comprising:
a support structure having a width to span a user's torso and a depth to raise the user's torso off of an underlying surface when the user is in a prone position on the support structure; and
a massaging device coupled to or embedded within the support structure at an offset location, nearer to one lateral edge of the support structure than to an opposing lateral edge of the support structure, to dispose the massaging device approximately in alignment with the user's ileocecal valve;
wherein the massaging device comprises a control switch to control an operating state of the massaging device.

2. The system of claim 1, wherein the massaging device comprises a localized massaging device to concentrate massaging movements from the massaging device at the user's ileocecal valve.
